(19) United States
(12) Patent Application Publication
(10) Pub. No.: US 2026/0184044 A1
(43) Pub. Date: Jul. 2, 2026

(54) METHOD FOR MANUFACTURING POROUS LAMINATED STRUCTURE USING SINGLE-CRYSTAL METAL NANOPLATES AND POROUS LAMINATED STRUCTURE MANUFACTURED THEREBY

(71) Applicants: INDUSTRIAL COOPERATION FOUNDATION CHONBUK NATIONAL UNIVERSITY, Jeonju-si (KR); KOREA INSTITUTE OF SCIENCE AND TECHNOLOGY, Seoul (KR)

(72) Inventors: Tae Wook KIM, Yongin-si (KR); Ju Young JIN, Jeonju-si (KR); Hyun Jung LEE, Gwangju (KR); SuKang BAE, Daejeon (KR); Ji Eon KWON, Wanju-gun (KR); Byung Joon MOON, Jeonju-si (KR); Sang Kyu PARK, Sejong-si (KR)

(73) Assignees: INDUSTRIAL COOPERATION FOUNDATION CHONBUK NATIONAL UNIVERSITY, Jeonju-si (KR); KOREA INSTITUTE OF SCIENCE AND TECHNOLOGY, Seoul (KR)

(21) Appl. No.: 19/424,715

(22) Filed: Dec. 18, 2025

(30) Foreign Application Priority Data
Dec. 31, 2024 (KR) 10-2024-0302746

(51) Int. Cl. B32B 15/04; B32B 3/10; B32B 15/20; B32B 38/16

(52) U.S. Cl. CPC B32B 15/04; B32B 3/10; B32B 15/20; B32B 38/162; B32B 2305/026; B32B 2305/30; B32B 2307/72; B32B 2307/7376; B32B 2310/0418; B32B 2311/12; B32B 2457/10

(57) ABSTRACT

The method for manufacturing a porous laminated structure, includes: a step of preparing a substrate; and a metal plate lamination step of laminating single-crystal metal nanoplates on the substrate. The present disclosure aims to provide a lamination type structure based on single-crystal metal nanoplates to suppress the formation of lithium dendrites generated in lithium metal batteries and improve battery performance and stability. Furthermore, the present disclosure provides a technique for using a laminated structure of single-crystal metal nanoplates as a current collector, thereby providing high specific surface area and conductivity, and inducing uniform lithium deposition.

### CROSS-REFERENCE TO RELATED APPLICATION

This application claims the benefit of and priority to Korean Patent Application No. 10-2024-0202746, filed on Dec. 31, 2024, the entire disclosure(s) of which is hereby incorporated herein by reference in its entirety.

### TECHNICAL FIELD

The present disclosure relates to a method for manufacturing a porous laminated structure using single-crystal metal nanoplates and to the porous laminated structure manufactured thereby.

This research is research that was conducted with funding from the Ministry of Science and ICT and support from the Korea Institute for Science and Technology Promotion (KISTP) (2023, “Academic-Research Cooperation Platform Construction Pilot Project”).

### BACKGROUND ART

Lithium metal batteries are secondary batteries that use lithium metal as the anode, and are next-generation energy storage devices that offer higher energy densities and faster charging speeds than conventional lithium-ion batteries. Lithium metal batteries have a theoretical capacity approximately 10 times higher than conventional lithium-ion batteries that use graphite as the anode material, and play a crucial role in diverse applications such as electric vehicles, large-scale energy storage systems, and portable electronic devices.

While lithium metal batteries offer high performance, they suffer from the problem of lithium dendrites grown on the anode surface. Lithium dendrites are generated by the uneven deposition of lithium ions, which can lead to battery internal short circuits, performance degradation, and the explosion risk. Therefore, a current collector design that can suppress lithium dendrite growth and induce uniform lithium deposition is required.

Conventional lithium metal batteries primarily use copper foil as a current collector. However, copper foil has a polycrystalline structure in which a variety of crystal planes are mixed and has an uneven surface potential energy. This structural characteristic causes lithium ions to deposit concentratedly in specific regions, resulting in uneven lithium layer formation and lithium dendrite growth. Due to this, there are problems of reduced battery performance and stability.

Recent research has focused on developing current collectors for lithium metal batteries using two-dimensional nanomaterials and single-crystal metal structures. Two-dimensional metal nanomaterials offer high electrical conductivity and a high specific surface area, which can significantly improve the efficiency of electrochemical reactions. In particular, single-crystal metal nanoplate-based laminated structures exhibit superior electrical conductivity and structural uniformity compared to conventional polycrystalline metal foils, and are evaluated as materials suitable for lithium metal battery anode current collectors.

Previous technologies have failed to effectively suppress uneven lithium deposition and dendrite formation due to the uneven crystal structure of copper foil. Accordingly, there is a need to develop a single-crystal metal nanoplate-based layered current collector that can induce stable and uniform lithium deposition.

### DISCLOSURE

### Technical Problem

The present disclosure is for solving the above-described problems, and the present disclosure aims to provide a lamination type structure based on single-crystal metal nanoplates, when the lamination type structure is used as a current collector, to suppress the formation of lithium dendrites generated in lithium metal batteries and improve battery performance and stability.

Furthermore, the present disclosure provides a technique for using a laminated structure of single-crystal metal nanoplates as a current collector, thereby providing high specific surface area and conductivity, and inducing uniform lithium deposition.

The objectives of the present disclosure are not limited to those mentioned above, and other objectives and advantages of the present disclosure not mentioned can be understood through the following description and will be more clearly understood by the embodiments of the present disclosure. Furthermore, it will be readily apparent that the objectives and advantages of the present disclosure can be realized by the means and combinations thereof set forth in the claims.

### Technical Solution

The present disclosure provides a method for manufacturing a porous laminated structure, comprising: a step of preparing a substrate; and a metal plate lamination step of laminating single-crystal metal nanoplates on the substrate.

The pretreatment solution may be acetone or isopropyl alcohol in the pretreatment step in which the step of preparing the substrate is a step of immersing the substrate in a pretreatment solution to remove organic matter and impurities on the substrate.

The substrate in the pretreatment step may be one or more of copper (Cu), glass, a glass substrate having a copper or metal thin film formed thereon, a plastic substrate, SiO₂/Si, PET, PDMS, polyimide (PI), and combinations thereof.

The metal plates in the metal plate lamination step may be single-crystal copper nanoplates.

The single-crystal copper nanoplates may have one of a circular, triangular, square, pentagonal, hexagonal, or oval shape.

The copper nanoplates may have a lamination density of 0.05 to 10 mg/cm², preferably 0.5 to 3 mg/cm².

The lamination thickness in the metal plate lamination step may be 50 nm to 100 μm, preferably 50 nm to 30 μm.

The porous laminated structure may be used as one for current collectors.

The present disclosure may also provide: a substrate; and a porous laminated structure in which single-crystal metal nanoplates are laminated on the substrate.

The present disclosure also provides a porous laminated structure manufactured by a method for manufacturing a porous laminated structure.

The porous laminated structure has lithium deposited in the internal spaces thereof.

### Advantageous Effects

Lithium ions are induced so that they are uniformly deposited through the uniform structure and high specific surface area of single-crystal metal nanoplates, thereby enabling the growth of lithium dendrites to be suppressed during the charge/discharge process, and enabling battery life and stability to be significantly improved due to high charge/discharge efficiency.

The size and lamination amount of single-crystal metal nanoplates are adjusted, and thus the characteristics of the current collector are optimized for applications so that current collectors suitable for lithium metal battery applications with diverse sizes and requirements can be manufactured.

### DESCRIPTION OF DRAWINGS

FIG. 1 shows a schematic diagram of a lithium metal battery current collector and lithium deposition based on a laminated structure of single-crystal metal nanoplates.

FIG. 2 shows X-ray diffraction (XRD) data, electron backscatter diffraction (EBSD) data, and energy dispersive spectroscopy (EDS) analysis results of single-crystal copper nanoplates with a synthesized (111) plane.

FIG. 3 shows photographs, and optical microscopic and scanning electron microscopic photographs of the manufactured single-crystal copper nanoplate laminated structure.

FIG. 4 shows (i) a schematic diagram of a coin cell using the single-crystal copper nanoplate laminated structure as an anode current collector, (ii) results of measuring open circuit potentials of coin cells based on laminated structures with adjusted amounts of copper nanoplates, and (iii) results of measuring electrochemical impedances of coin cells based on copper nanoplates depending on lamination amount.

FIG. 5 shows (i) charge-discharge behaviors of coin cells based on various copper single-crystal laminated structures and (ii) overpotential results of lithium nucleus growth on the surface of the current collector.

FIG. 6 shows (i) Coulombic efficiencies of single-crystal copper nanoplate laminated structure coin cells over charge-discharge cycles and (ii) voltage profile results in the charge-discharge cycles.

FIG. 7 shows images of laminated structures according to the lamination density of copper nanoplates according to one embodiment of the present disclosure.

FIG. 8 shows images of lithium deposition over time in the internal spaces of copper nanoplates according to one embodiment of the present disclosure.

### MODE FOR INVENTION

A method for manufacturing a porous laminated structure of the present disclosure comprises a step of preparing a substrate and a metal plate lamination step.

### Step of Preparing a Substrate

The pretreatment solution may be acetone or isopropyl alcohol in the pretreatment step in which the step of preparing the substrate is a step of immersing the substrate in a pretreatment solution to remove organic matter and impurities on the substrate.

The pretreatment step is a process of preparing the surface of the substrate to be used as a current collector, and the focus is on removing organic matter and impurities present on the substrate to enable the uniform attachment of single-crystal metal nanoplates. To this end, the substrate is treated with an appropriate pretreatment solution, and this process ensures cleanliness and uniformity of the substrate surface and enables the stable lamination of metal nanoplates in a subsequent step.

### Metal Plate Lamination Step

It is a step of laminating single-crystal metal nanoplates on the substrate. The metal nanoplates may have a size ranging from 1 nm to 25 μm and a thickness ranging from 1 nm to 1,000 nm, preferably from 20 nm to 80 nm.

In the metal plate lamination step, the metal plates may be single-crystal copper nanoplates.

The single-crystal copper nanoplates may have a circular, triangular, square, pentagonal, hexagonal, or oval shape.

The copper nanoplates may have a lamination density of 0.05 to 10 mg/cm², preferably 0.5 to 3 mg/cm².

In the metal plate lamination step, the lamination thickness may be 50 nm to 30 μm, preferably 90 nm to 110 μm.

The metal nanoplates refer to nano-sized metal materials having a two-dimensional flat plate structure.

The metal nanoplates are not only manufactured to have various sizes and shapes, but also manufactured to have various surface roughnesses. Accordingly, they may be widely used in various fields such as various semiconductor devices; electromagnetic shielding; transparent electrodes; photoelectric materials; catalysts; fuel cells; inks; nanomaterials for printed electronics including pastes, coatings, and the like; etc.

In the metal plate lamination step, single-crystal metal nanoplates are laminated onto a pretreated substrate to form a structure. The single-crystal metal nanoplates are uniformly arranged on the substrate, and the size, thickness, and lamination density of the nanoplates are adjusted according to the application purpose in the lamination process. This step is designed to ensure that the single-crystal metal nanoplates maintain a stable and uniform structure while providing a high specific surface area and excellent conductivity.

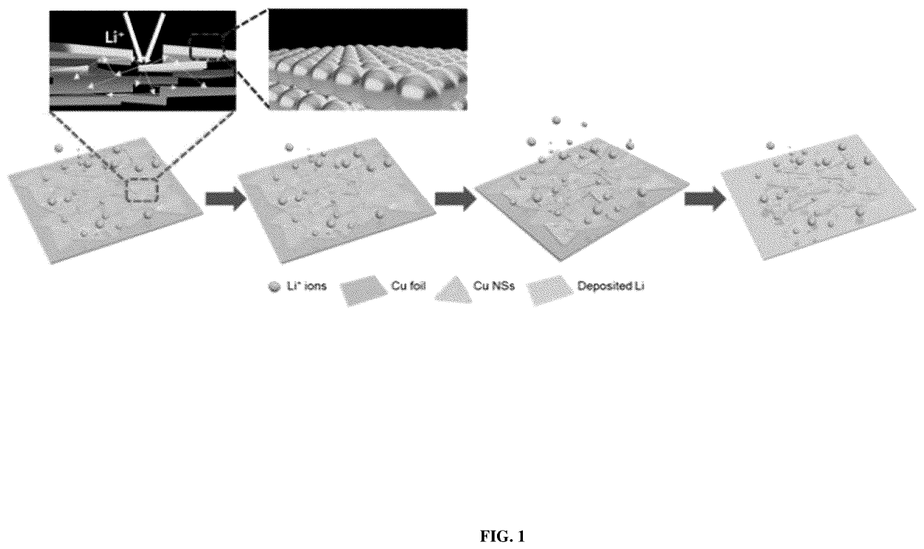

The lamination method is not particularly limited, and as shown in FIG. 1, the lamination of a plurality of metal nanoplates forms spaces between the metal nanoplates, resulting in a porous laminated structure in the laminated structure. The surface contact between such a porous laminated structure and the metal nanoplates enhances electrical conductivity.

The present disclosure is described in more detail below through Examples and Experimental Examples. However, these Examples and Experimental Examples are intended to exemplify the present disclosure and are not intended to limit the scope of the present disclosure.

FIG. 1 shows a schematic diagram of a lithium metal battery current collector and lithium deposition based on a laminated structure of single-crystal metal nanoplates.

As shown in FIG. 1, a lamination type structure is manufactured on copper foil using single-crystal metal nanoplates having a (111) plane as the basal plane so that the lamination type structure can be used as a current collector for lithium metal batteries, especially non-anode lithium batteries.

In the case of used copper foil, which is commonly used as a current collector for lithium metal batteries, it is polycrystalline and features a mixture of various crystal planes (e.g., (100), (110), (111), etc.). In the present disclosure, a laminated structure of large single-crystal metal nanoplates formed with a (111) plane, several to several tens of micrometers in size, can be used as a current collector.

The present disclosure relates to the shape of metal nanoplates and the effects of a lamination type structure of metal nanoplates, necessary for the development of a current collector for high-performance lithium metal batteries, and a lamination type structure based on single-crystal two-dimensional metal nanoplates can be used as a current collector for lithium batteries, particularly as an anode current collector for non-anode lithium batteries.

When a structure in which metal single crystals of a (111)-plane is laminated in a layered shape is manufactured through this and used as a current collector for non-anode lithium batteries, it possesses a higher specific surface area than conventional current collectors using flat surface copper foil, thereby enhancing active sites for lithium deposition and thus enabling energy density to be increased.

Furthermore, lamination of large single crystals increases the bonding surface between metal nanoplates so that it is possible to provide superior horizontal and vertical electrical and ionic conductivities, and only (111) single-crystal copper nanoplates is used to induce uniform lithium deposition on the anode current collector, thereby enabling lithium dendrite growth to be suppressed.

When manufacturing a laminated structure using single-crystal metal nanoplates, the shape of the laminated structure changes depending on the size and quantity of the metal nanoplates used so that this changes the specific surface area of the current collector on which lithium may be deposited during charging of a non-anode lithium metal battery, thereby altering and improving battery performance.

Furthermore, battery performance and stability can be improved by mixing single-crystal metal nanoplates of different sizes and thus adjusting the bonding sites between the metal nanoplates within the laminated structure.

Single-crystal metal nanoplates measuring tens of nanometers in thickness and several to tens of micrometers in size are introduced so that a lamination type structure utilizing two-dimensional single-crystal metal nanoplates can provide a significantly larger surface area capable of depositing lithium during battery charging compared to commercial metal foils.

Furthermore, the highly conductive metal nanoplates can form surface contacts, effectively reducing the contact resistance of the lamination type structure compared to zero-dimensional nanoparticles and one-dimensional nanowire-based lamination type structures, thereby enhancing ionic and electrical conductivities between the horizontal and vertical layers.

A laminated structure in which only (111) copper single-crystal plates are stacked possesses a uniform surface potential energy, thereby enabling stable and uniform lithium deposition, and when a lamination type structure based on single-crystal metal nanoplates is used as an anode current collector in a lithium metal battery, it can significantly enhance battery performance and stability.

As the amount of (111) copper single crystal plates laminated is adjusted, since a uniform structure with excellent conductivity for smooth lithium deposition and desorption can be manufactured, and this can affect battery performance, the problem of lithium dendrites and dead lithium formation can be solved by forming a metal nanoplate lamination type structure with excellent interlayer conductivity is formed and using it as a current collector for non-anode lithium metal batteries to induce uniform lithium deposition.

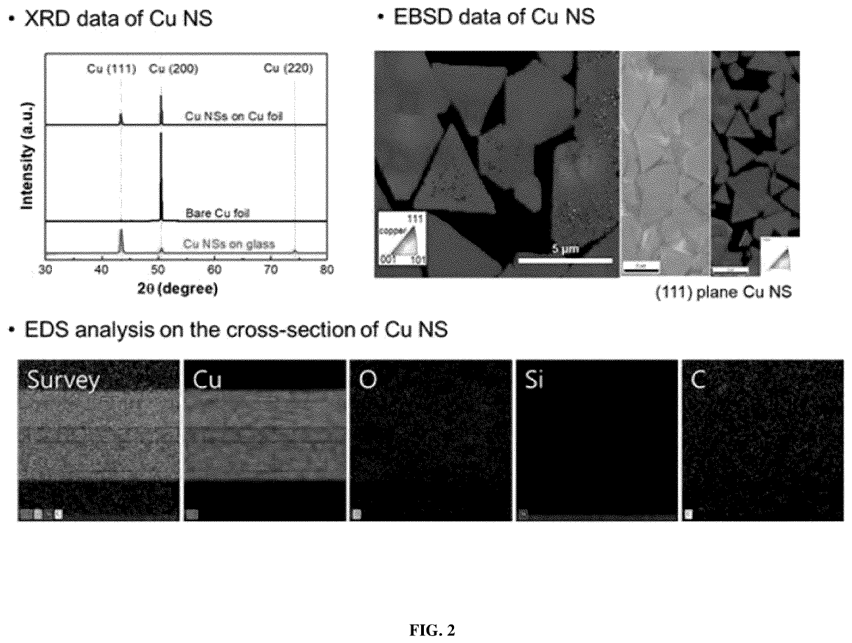

FIG. 2 shows XRD data, EBSD data, and EDS analysis results of single-crystal copper nanoplates with a synthesized (111) plane.

The synthesis of single-crystal copper nanoplates in which only the (111) plane is present was confirmed through XRD and EBSD analyses of the synthesized copper nanoplates, and the results are as shown in FIG. 2.

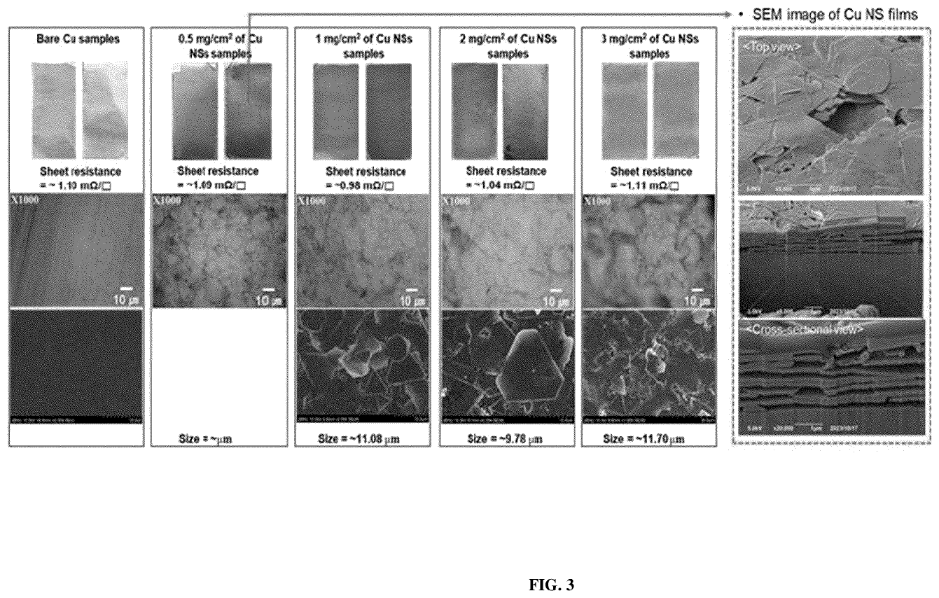

FIG. 3 shows photographs, and optical microscopic and scanning electron microscopic photographs of the manufactured single-crystal copper nanoplate laminated structure.

Laminated structures in which single-crystal copper nanoplates synthesized on copper foil were laminated at densities ranging from 0.5 to 3 mg/cm 2 were manufactured, and the morphologies of the laminated structures were confirmed to be different depending on the amount of copper nanoplates, and the results thereof are as shown in FIG. 3.

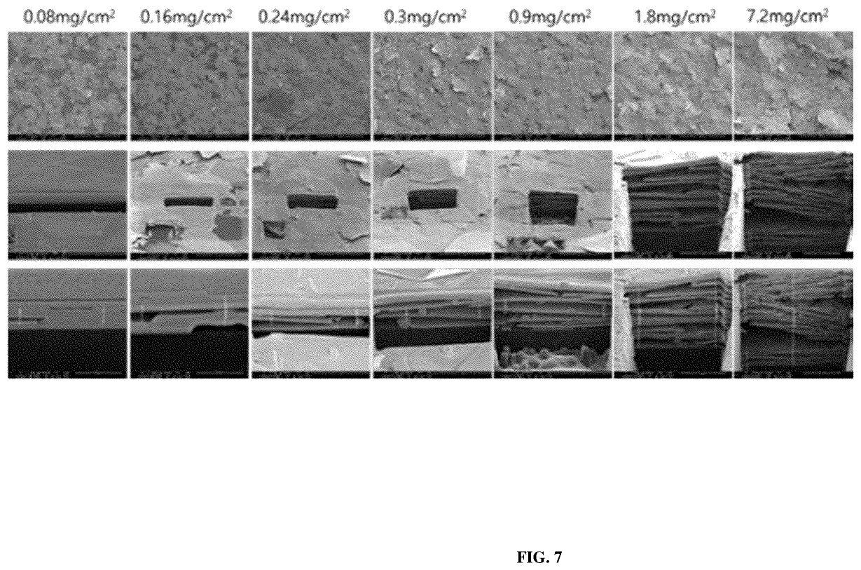

Furthermore, laminated structures in which single-crystal copper nanoplates synthesized on copper foil were laminated at densities ranging from 0.08 to 7.2 mg/cm² were manufactured, and the results are shown in FIG. 7.

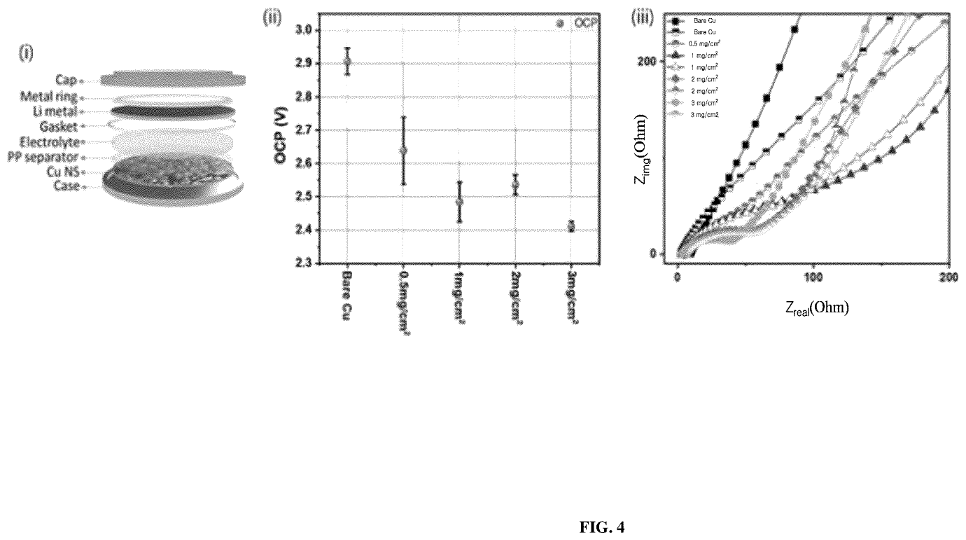

FIG. 4 shows (i) a schematic diagram of a coin cell using the single-crystal copper nanoplate laminated structure as an anode current collector, (ii) results of measuring open circuit potentials of coin cells based on laminated structures with adjusted amounts of copper nanoplates, and (iii) results of measuring electrochemical impedances of coin cells based on copper nanoplates depending on lamination amount.

2032-coin cells were manufactured as shown in (i) of FIG. 4 to utilize the copper nanoplate laminated structure as an anode current collector for lithium metal batteries.

The electrolyte used a polypropylene separator as 1M LiPF₆ EC/DEC (3/7 vol) with 10 wt % FEC.

After manufacturing the coin cells, they were subjected to incubation at 25° C. for at least 6 hours or more, and then the open circuit potential and electrochemical impedance spectroscopy of the coin cells were measured, and the results are as shown in FIG. 4.

It was confirmed that coin cells with increased lamination amounts of the copper nanoplates exhibited lower open circuit potential and charge transfer resistance through FIG. 4 (ii) and (iii).

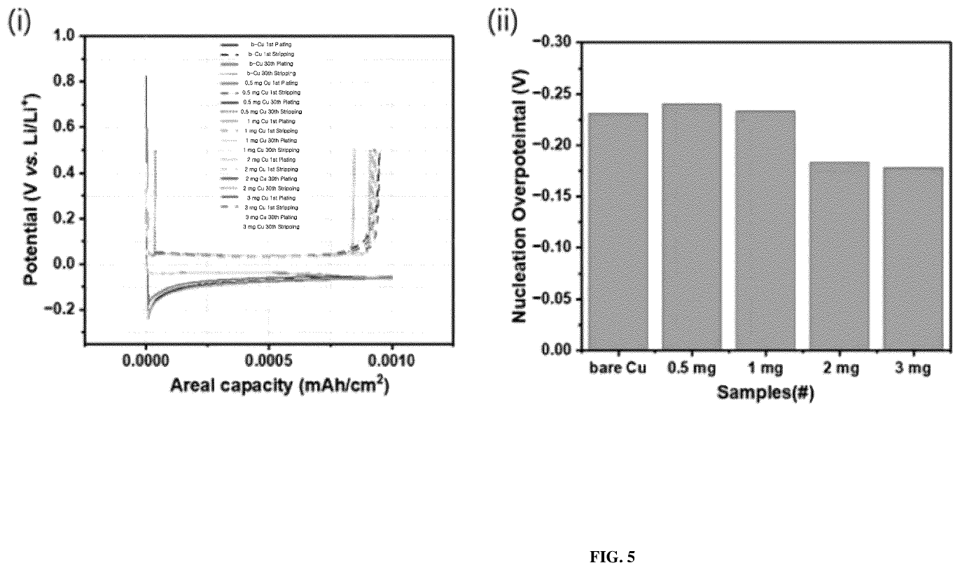

FIG. 5 shows (i) charge-discharge behaviors of coin cells based on various copper single-crystal laminated structures and (ii) overpotential results of lithium nucleus growth on the surface of the current collector.

As a result of observing the charge-discharge behaviors of coin cells using copper nanoplate laminated structures as anode current collectors, coin cells based on single-crystal copper nanoplate laminated structures exhibited reversible charge-discharge behaviors compared to bare Cu foil, and it was confirmed that the lithium nucleus growth overpotential on the current collector surface based on copper nanoplates was lower during the initial charge-discharge cycle, and the lithium nucleus growth overpotential was decreased as the amount of copper nanoplate laminated increased.

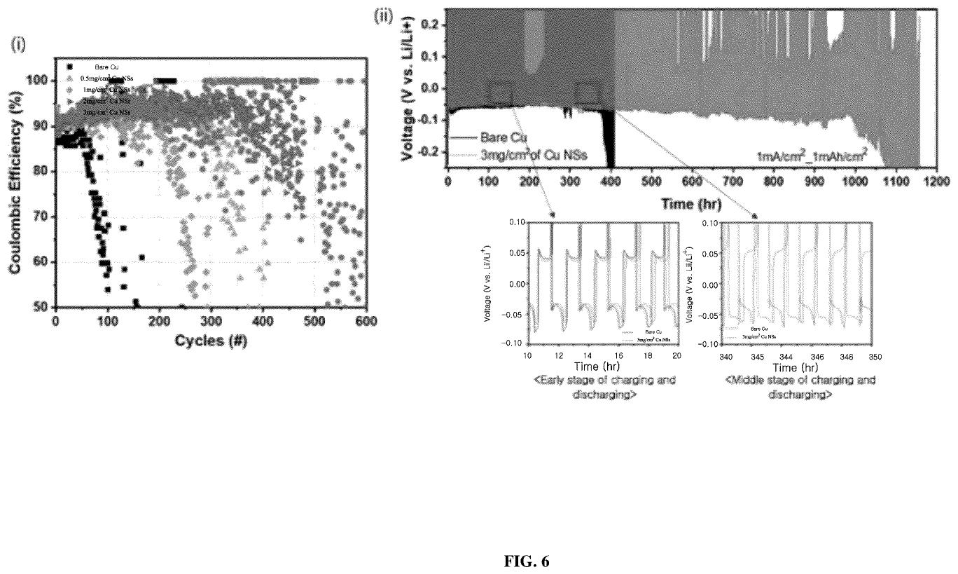

FIG. 6 shows (i) Coulombic efficiencies of single-crystal copper nanoplate laminated structure coin cells over charge-discharge cycles and (ii) voltage profile results in the charge-discharge cycles.

As results of measuring the Coulombic efficiencies of coin cells using an anode current collector based on a copper nanoplate laminated structure during charge/discharge cycles, it was confirmed that the coin cells based on the copper nanoplate laminated structure exhibited higher and more stable Coulombic efficiencies than the conventionally used bare Cu foil-based coin cells, and the results are as shown in (i) of FIG. 6.

Furthermore, while bare Cu foil exhibited an abnormal voltage profile after 340 cycles, it was confirmed that the coin cells of the laminated structure in which 3 mg of copper nanoplates was laminated exhibited a normal voltage profile similar to the initial cycle and exhibited sustained battery performance, and the results are as shown in (ii) of FIG. 6.

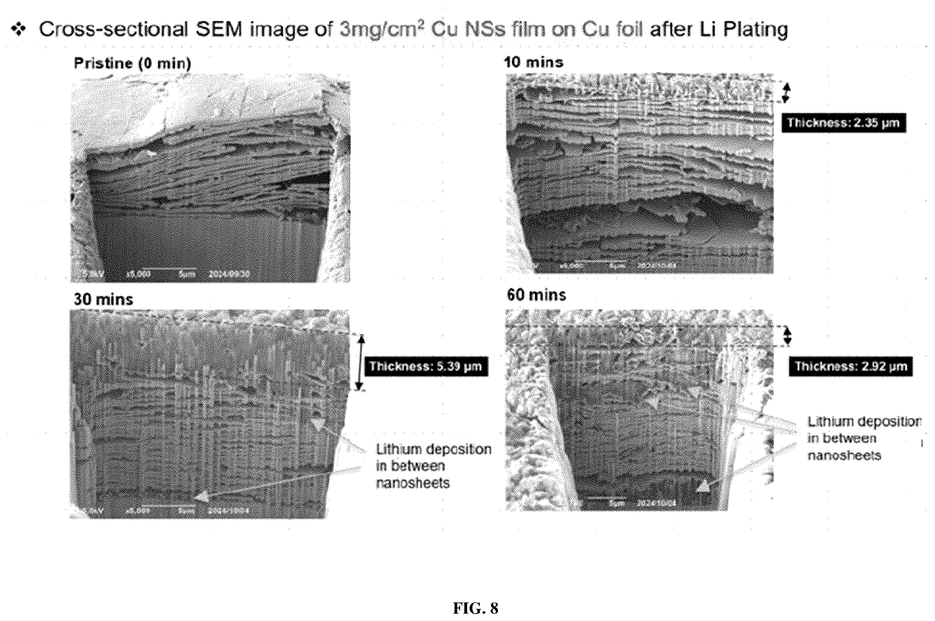

Furthermore, the time-dependent patterns are shown in FIG. 8 while depositing lithium on the laminated structure in which copper nanoplates are laminated at a density of 3 mg/cm² on the top of copper foil. As shown in FIG. 8, it can be confirmed that the thickness of the laminated lithium increases as lithium is laminated on the top of the laminated structure in the initial lithium deposition phase, and laminated lithium is thinned as some of lithium laminated on the top of the laminated structure is embedded in the structure with the passage of time. On this wise, it can be confirmed that lithium is deposited within spaces inside the porous laminated structure according to one embodiment of the present disclosure, i.e., the spaces between the metal nanoplates.

1. A method for manufacturing a porous laminated structure, comprising:
a step of preparing a substrate; and
a metal plate lamination step of laminating single-crystal metal nanoplates on the substrate.

2. The method of claim 1, wherein the step of preparing the substrate is a step of immersing the substrate in a pretreatment solution to remove organic matter and impurities on the substrate, and the pretreatment solution is acetone or isopropyl alcohol.

3. The method of claim 1, wherein the substrate in the pretreatment step is one or more of copper (Cu), glass, a glass substrate having a copper or metal thin film formed thereon, a plastic substrate, SiO₂/Si, PET, PDMS, polyimide (PI), and combinations thereof.

4. The method of claim 1, wherein the metal plates in the metal plate lamination step are single-crystal copper nanoplates.

5. The method of claim 4, wherein the single-crystal copper nanoplates have one of a circular, triangular, square, pentagonal, hexagonal, or oval shape.

6. The method of claim 4, wherein the copper nanoplates have a lamination density of 0.05 to 10 mg/cm².

7. The method of claim 1, wherein the lamination thickness in the metal plate lamination step is 50 nm to 100 μm.

8. The method of claim 1, wherein the porous laminated structure is for current collectors.

9. A porous laminated structure manufactured by the method for manufacturing a porous laminated structure of claim 1.

10. The method of claim 9, wherein the porous laminated structure has lithium deposited in the internal spaces thereof.
